(19) United States
(12) Patent Application Publication
(10) Pub. No.: US 2022/0200231 A1
(43) Pub. Date: Jun. 23, 2022

(54) RARE-EARTH-DOPED ALUMINA-OXIDE LASER GAIN MEDIA

(71) Applicant: The Regents of the University of California, Oakland, CA (US)

(72) Inventors: Javier E. Garay, San Diego, CA (US); Elias H. Penilla, Upland, CA (US); Yasuhiro Kodera, San Diego, CA (US)

(21) Appl. No.: 17/425,940

(22) PCT Filed: Jan. 24, 2020
(86) PCT No.: PCT/US20/15094

§ 371 Date: Jul. 26, 2021

Related U.S. Application Data
(60) Provisional application No. 62/797,139, filed on Jan. 25, 2019.

(51) Int. Cl. H01S 3/16; C09K 11/77

(52) U.S. Cl. CPC H01S 3/1636; C09K 11/7774; C09K 11/7758; H01S 3/1611

(57) ABSTRACT

A laser apparatus and a polycrystalline material are described. The apparatus includes the polycrystalline material which is configured to receive pumping light at a pump wavelength and to produce an optical gain for laser oscillation at a laser wavelength different from the pump wavelength. The polycrystalline material includes a ceramic material with a predetermined grain size. The polycrystalline material further includes a rare earth dopant with a predetermined concentration, wherein the predetermined grain size and the predetermined concentration cause the polycrystalline material to exhibit the optical gain at the laser wavelength.

### CROSS-REFERENCE TO RELATED APPLICATION

This patent document claims priority to and benefits of U.S. Provisional Patent Application No. 62/797,139, entitled “RARE-EARTH-DOPED ALUMINA-OXIDE LASER GAIN MEDIA,” filed on Jan. 25, 2019. The entire content of the above patent application is incorporated by reference as part of the disclosure of this patent document.

### STATEMENT REGARDING FEDERALLY SPONSORED RESEARCH

This invention was made with government support under W911NF-16-1-0571 awarded by the U.S. Army Research Office. The government has certain rights in the invention.

### TECHNICAL FIELD

This patent document relates to lasers and materials for producing optical gain in lasers.

### BACKGROUND

The past decade has seen significant advances in the development of high-energy laser (HEL) technologies, with improvements in pumping technology, cavity design, cooling methods, and improved gain media quality. The search for gain media with superior optical, thermal, and mechanical properties remains intense because improvements in the materials properties translate directly to increases in device performance. Advanced laser gain materials that provide access to different wavelengths, tunability, short pulses, etc. have paved the way for the study of light-matter interactions, break-through medical applications, and imaging/spectroscopy.

### SUMMARY

Alumina (Al₂O₃) used as an optical gain material has a higher fracture strength and thermal conductivity than current gain materials, which could lead to improved laser performance. Alumina also has uniaxial optical proprieties and the solubility of rare earth materials (REs) is two-to-three orders of magnitude lower than dopant concentrations in some RE-based gain media. The disclosed subject matter may be used to overcome these obstacles and demonstrate gain in a RE-doped alumina (Nd:Al₂O₃). The disclosed subject matter may be used to tailor the crystallite size to other length scales such as a wavelength of light and interatomic dopant distances, which minimizes the optical losses and allows for successful Nd doping.

In one aspect, a laser apparatus is disclosed. The apparatus includes a polycrystalline material configured to receive pumping light at a pump wavelength and to produce an optical gain for laser oscillation at a laser wavelength different from the pump wavelength. The polycrystalline material includes a ceramic material with a predetermined grain size. The polycrystalline material further includes a rare earth dopant with a predetermined concentration, wherein the predetermined grain size and the predetermined concentration cause the polycrystalline material to exhibit the optical gain at the laser wavelength.

In another aspect, a polycrystalline material is disclosed. The polycrystalline material includes a ceramic material with a predetermined grain size, and a rare earth dopant with a predetermined concentration, wherein the predetermined grain size and the predetermined concentration cause the polycrystalline material to exhibit optical gain at a predefined wavelength.

The following features can be included in various combinations. The predetermined grain size is less than the pump wavelength. A distribution of the rare earth dopant has a minimal segregation at grain boundaries. The pump wavelength of the pumping light is 806 nanometers. The laser wavelength and a predefined wavelength are 1064 nanometers. The laser wavelength and the predefined wavelength lie between 1000 nm and 2000 nm. The ceramic material is alumina (Al₂O₃). The rare earth dopant is neodymium (Nd). The rare earth dopant is one or more of neodymium (Nd), erbium (Er), thulium (Tm), holmium (Ho) or ytterbium (Yb).

Additional features are disclosed in the specification, figures, and the claims.

### BRIEF DESCRIPTION OF THE DRAWINGS

FIG. 1 summarizes a strategy for obtaining gain in Nd:Al₂O₃, in accordance with some example embodiments;

FIG. 2A shows the effect of current activated pressure assisted densification (CAPAD) temperature on the relative density of undoped samples and others doped with 0.25 and 0.35 at. % Nd, in accordance with some example embodiments;

FIG. 2B shows an example of transparency of doped and undoped Al₂O₃ powder, in accordance with some example embodiments;

FIG. 2C shows examples of x-ray diffraction spectra of fully dense polycrystals, in accordance with some example embodiments;

FIG. 3 depicts an example of a high-angle annular dark-field (HAADF) TEM micrograph and corresponding energy-dispersive X-ray spectroscopy (EDS) distribution maps of a 0.35 at. % Nd:Al₂O₃ polycrystal (T=1260° C., HT=5 min, HR=300° C. min⁻¹, CR=300° C. min⁻¹), in accordance with some example embodiments;

FIG. 4A depicts an example of optical transparency of consolidated bulk Nd:Al₂O₃ polycrystals, in accordance with some example embodiments;

FIG. 4B depicts examples of transmission spectra, in accordance with some example embodiments;

FIG. 4C shows examples of emission spectra resulting from pumping at λ=806 nm for doped Al₂O₃, doped glass (Schott), and doped YAG (single crystal), in accordance with some example embodiments;

FIG. 4D depicts examples of lifetimes for doped Al₂O₃, in accordance with some example embodiments;

FIG. 4E depicts an example of emissions spectra for doped Al₂O₃, in accordance with some example embodiments;

FIG. 5A depicts an example of an apparatus for measuring optical gain, in accordance with some example embodiments; and

FIG. 5B depicts an examples of gain coefficients, in accordance with some example embodiments.

### DETAILED DESCRIPTION

Section headings are used in the present document only for ease of understanding and do not limit scope of the embodiments to the section in which they are described.

Traditionally accepted design paradigms dictate that only optically isotropic (cubic) crystal structures with high equilibrium solubility of optically active ions are suitable for polycrystalline laser gain media. The restriction of symmetry is due to light scattering caused by randomly oriented anisotropic crystals, while the solubility arises from the need for sufficient active dopants in the media. These criteria can limit material choices and exclude materials that have superior thermo-mechanical properties over the state-of-the-art laser materials. As disclosed herein, Alumina (Al₂O₃) is an example; it has a higher fracture strength and thermal conductivity than current gain materials, which could lead to improved laser performance. Alumina also has uniaxial optical proprieties and the solubility of rare earth materials (REs) can be two-to-three orders of magnitude lower than dopant concentrations in typical RE-based gain media. The disclosed subject matter may be used to overcome these obstacles and demonstrate gain in a RE-doped alumina (Nd:Al₂O₃). The disclosed subject matter may be used to tailor the crystallite size to other length scales—wavelength of light and interatomic dopant distances, which minimizes optical losses and allows for successful Nd doping. The result is a laser gain medium with a thermo-mechanical figure of merit of Rₛ˜19,500 Wm⁻¹, a 24 and 19,500 fold improvement over high-energy-lasers such as Nd:YAG (Rₛ˜800 Wm⁻¹) and Nd:Glass (Rₛ˜1 Wm⁻¹), respectively. Moreover, the emission bandwidth of Nd:Al₂O₃ is broad at ˜13 THz. The successful demonstration of gain and high bandwidth in a media with superior Rs leads to lasers with previously unobtainable high-peak powers, short-pulses, tunability, and high-duty-cycles. A polycrystalline laser gain media produces optical amplification.

Single-crystals and glasses dominate the gain media market, but polycrystalline ceramics have advantages such as improved mechanical properties and gradient doping. Ceramics also have the potential to improve thermal management of gain media. The power deliverable by a laser scales directly with the thermal conductivity k, and the fracture stress σ_{F}, places a limit of failure such that the figure of merit for a gain material is given by:

$${R}_{s} = \frac{k ( 1 - v )}{α E} {σ}_{F} \qquad Equation ( 1 )$$

where E is the elastic modulus, a is the coefficient of thermal expansion and v is Poisson's ratio. The low thermal conductivities of leading gain media (˜1-2 Wm⁻¹K⁻¹ RE:Glass, and 7-14 Wm⁻¹K⁻¹ RE:YAG) continue to limit the power scaling of HELs.

Cubic materials such as RE-host media may have higher k than YAG. Cubic-symmetry materials such as garnets and RE-sesquioxides are transparent ceramics because grain growth need not be avoided to mitigate birefringence scattering and they readily accommodate RE dopants due to the similarity in ionic radii between dopant and cations. To supplant RE:Glass and/or RE:YAG, a gain material with substantially better thermo-mechanical properties is needed.

Sapphire/alumina may be a RE host because Al₂O₃ offers superior thermal conductivity (k˜30-35 Wm⁻¹K⁻¹) and a high-fracture toughness (3.5 MPam^{-1/2}), the combination of which leads to a superior thermal shock resistance (Rₛ˜19,500 Wm⁻¹) compared to Glass (Rₛ˜1 Wm⁻¹) and YAG (Rₛ˜800 Wm⁻¹). Moreover, sapphire has been used as a transition metal doped gain media. The addition of RE dopants at levels sufficient for gain could allow for efficient emission at other wavelengths, resulting in a laser gain medium with a combination of thermal, mechanical, and optical properties that will lead to more powerful lasers in scientific, medical, industrial, and mobile applications.

Two challenges to producing laser grade RE:Al₂O₃ ceramics include 1) the disparity in ionic radii between the RE³⁺ and Al³⁺, which leads to an equilibrium solubility ˜10⁻³%, lower than necessary for gain, and 2) the optical anisotropy arising from the hexagonal crystal structure of Al₂O₃ leads to birefringence scattering that must be mitigated to achieve high transparency.

Translucent alumina ceramics have been produced but no gain in RE:Al₂O₃ has not been demonstrated at least on part because RE:Al₂O₃ ceramics have not reached the necessary optical quality. The disclosed subject matter includes bulk polycrystalline Nd:Al₂O₃ ceramics that exhibit stimulated emission and optical gain. The disclosed gain can be achieved without single sight doping, i.e. with some Nd segregated to the grain boundaries. Using the disclosed subject matter, absorption bands in the transmission spectra are present thereby confirming the presence of optically active Nd³⁺ within the ceramic matrix. In some example embodiments, for the primary pumping band at 806 nm (⁴I_{9/2}→⁴F_{5/2}) the absorption cross-section is 1.36×10⁻²⁰ cm² and 1.69×10⁻²⁰ cm² for 0.25 at. % and 0.35 at. % Nd:Al₂O₃ ceramics, respectively.

In addition to improving thermal management, Nd:Al₂O₃ also addresses another challenge in HEL technologies—producing broadband emission in RE-doped media. Conventional gain media design aims for sharp single-site peaks resulting in lower lasing thresholds. The advantage of high bandwidth is wavelength tunability and allows the generation of short pulses (increased peak energy). In some example embodiments, when pumping at 806 nm, the ceramics show a 50 nm (FWHM), 13 THz peak at 1064 nm, (⁴F_{3/2}→⁴I_{11/2}). The fluorescence lifetime is ˜150 μs resulting in stimulated emission cross-sections as high as ˜9.8×10⁻²¹ cm². The 13 THz gain bandwidth arising from multi-site doping of Nd in Al₂O₃ for Nd³⁺ gain media could lead to pulses as short as 8 fs. The measured gain coefficient, gₒ, may be as high as 2.42 cm⁻¹ for 0.35 at. % Nd³⁺:Al₂O₃ at 1064 nm. The combination of thermal, mechanical and optical properties offered by Nd³⁺:Al₂O₃ opens the door to producing HEL with superior performance. Moreover, the approach presented herein is applicable to other anisotropic material systems that are not readily considered for optical applications. In some example embodiments, a polycrystalline material exhibits gain in one ore more wavelength bands, or the entire wavelength band between 1000 nm and 2000 nm. In some example embodiments, the rare earth dopant is one or more of Neodymium, Erbium (Er), Thulium (Tm), Holmium (Ho) or Ytterbium (Yb). A laser apparatus may include a polycrystalline material as described herein.

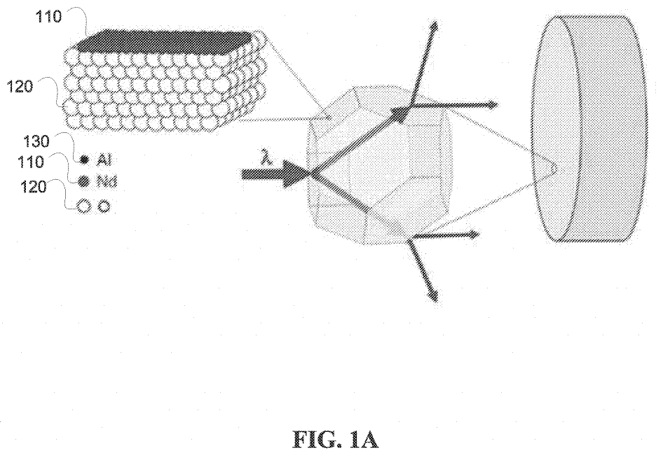

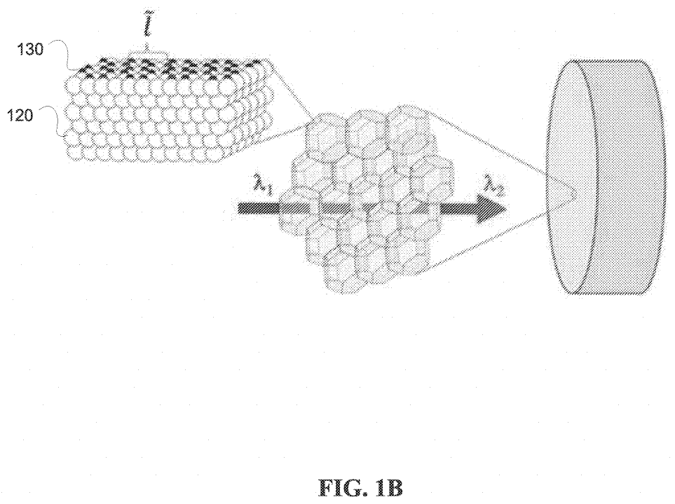

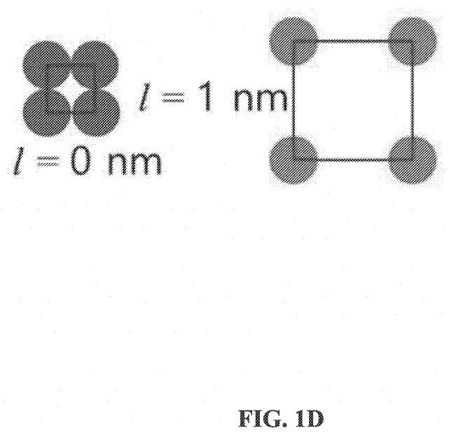

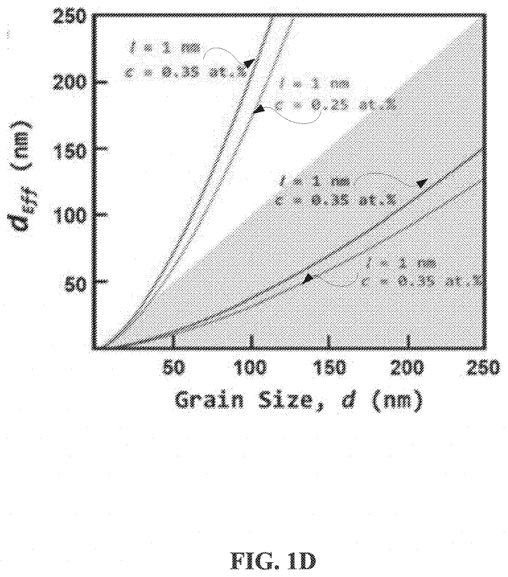

The disclosed techniques and materials for obtaining gain in Nd:Al₂O₃ include a nano/microstructure design that includes: 1) Crystallite sizes below the wavelength of pump and emitted light, and 2) Dopant distribution in the grain volumes with minimal segregation at the grain boundaries. FIGS. 1A-1D depict generally an example of a strategy for obtaining gain in Nd:Al₂O₃. In anisotropic ceramics with large grains, light is scattered at grain interfaces since they represent discontinuities in refractive index (FIG. 1A). However, as the grain size decreases, the scattering efficiency of uniaxial grains is lower. Thus, fine grained ceramics can be highly transparent media with losses low enough to achieve optical gain (FIG. 1B).

There are length scale relationships for achieving gain in anisotropic ceramics. FIG. 1A shows light scattered at grain interfaces in ceramics with large crystallites, since randomly oriented grains represent discontinuities in refractive index. RE segregation (represented as a close packed monolayer) at the grain boundary on section of Al₂O₃. For FIGS. 1A and 1B atoms 110 are Nd, atoms 120 are 0, and atoms 130 are Al. FIG. 1B shows scattering efficiency decreases significantly when pump (λ₁) and emitted light (λ₂) wavelengths are smaller than the grain size, permitting low optical losses. Small grains also permit spreading out of RE dopants at grain boundaries, increasing average interionic distance, \tilde{l} allowing for optical gain. FIG. 1C shows a close packed arrangement of dopant 1=0 and one with realistic interionic distance for gain (I=1 nm). FIG. 1D shows a calculation of grain size necessary to accommodate all the dopants for given dopant arrangement and concentration on the grain boundary, d_{eff} vs. grain size using Eq. 2 for two concentrations and arrangements shown in FIG. 1C.

In addition to low losses, RE dopant concentrations may be within a critical range; high enough to achieve a sufficient absorption cross-section and emission-cross-section, and low enough to prevent concentration quenching (energy relaxation through phonon rather than radiative photon processes) which occurs when ions are too closely spaced.

Traditional material processing can be employed in systems such as glasses and garnets where the RE solubility is high. However, in low solubility media, agglomeration occurs at grain boundaries (as shown in FIG. 1A). In the isotropic laser ceramics that have been demonstrated, grain sizes are typically 10-20 μm. In this large grain size case, there are relatively few grain boundary regions to accommodate the RE-dopant and the average distance between RE-ions decreases, resulting in luminescence quenching.

In the disclosed subject matter, the fine crystallite sizes that allow for high transparency in anisotropic polycrystalline materials play a role in absorption/emission by providing a possibility for higher RE incorporation without luminescence quenching. By reducing the grain size, the grain boundary volume increases. When holding the global dopant concentration constant while decreasing the grain size, RE dopants can ‘spread out’ along the grain boundaries, increasing the average distance, \tilde{l} between RE ions (FIG. 1B). For very fine-grained materials, it may be possible to reach dopant concentrations sufficient to achieve gain even without solubility in the grain interior. The effective grain size d_{eff} to accommodate all the dopants on the grain boundaries rather than grain interior depends on the arrangement of dopants on the boundary (function of \tilde{l}) and scales with d^{3/2} (see also the Materials and Methods section below).

To illustrate this scenario, an example d_{eff} is plotted as a function of grain size (Eq. 2) in FIG. 1D for various concentrations (at. % Nd) and dopant arrangements (FIG. 1C). The shaded regions in FIG. 1D are conditions in which it is possible to accommodate the global concentration of dopant atoms, c without any solubility in the grain. In the non-shaded regions, d_{eff}>d meaning that it is not possible to accommodate all the dopant ions without solubility in the grain. In the limiting case example of a close packed monolayer (\tilde{l}=0) (see FIG. 1C) it is possible to accommodate c=0.25 at. % and c=0.35 at. % of Nd on the grain boundary of a grain with d˜250 nm. The close-packed monolayer case may not lead to gain because the distance between RE-ions would result in luminescence quenching. Using a realistic value of \tilde{l}=1 nm, grain sizes <25 nm may be used to accommodate 0.35 at. % of Nd. Such small grain sizes may be alleviated because alumina does have solubility in the grain interiors under specific processing conditions and higher near the grain boundaries as will be discussed below. The high Nd equilibrium solubility in YAG is due to the more open crystal structure leading to a lower cation density compared to alumina. Since the cation density is higher in Al₂O₃, the volume concentration, cᵥₒₗ of Nd is higher in Al₂O₃ vs. YAG for a given at. % dopant. At c=0.25 at. %, cᵥₒₗ=1.18×10²⁰ for Nd:Al₂O₃ compared to cᵥₒₗ=9.26×10¹⁹ for Nd:YAG, an increase of ˜26%. Accordingly, a 0.25 at. % Nd:Al₂O₃ ceramic will contain a suitable concentration of RE for lasing.

To obtain gain in an Nd:Al₂O₃ bulk polycrystalline material, processing techniques that will produce fully dense ceramics with fine average grain size (AGS) and/or that offer processing widows with increased rare-earth solubility are needed. Fortunately, alumina does have Nd solubility that can be increased using high heating and cooling rates (to be discussed below), easing the necessity for extremely fine grains. Using a solid-state powder processing technique along with a one-step simultaneous reaction/densification approach with current activated pressure assisted densification (CAPAD), an Nd³⁺ dopant concentration as high as 0.35 at. % (Nd:Al ratio) can be achieved, approximately 350 times greater than the equilibrium solubility limit.

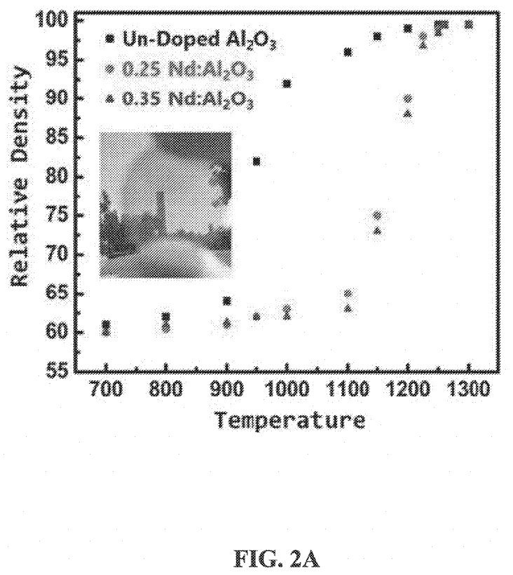

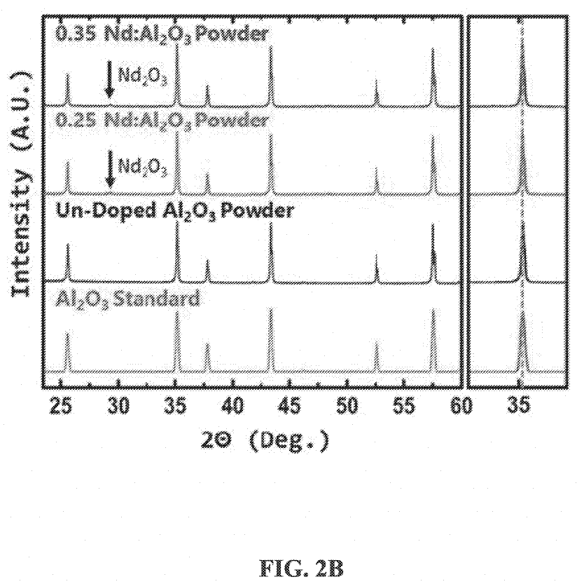

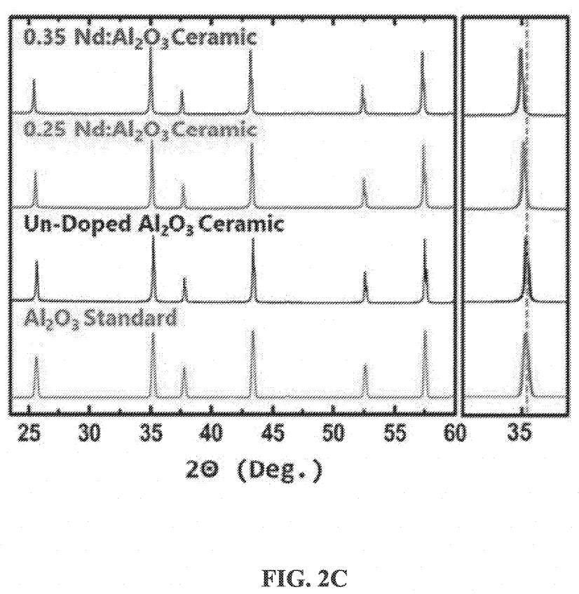

FIGS. 2A-2C depict an example of physical and microstructural characterization of Nd:Al₂O₃. FIG. 2A shows examples of the effect of CAPAD temperature on the relative density of un-doped and samples doped with 0.25 and 0.35 at. % Nd. FIG. 2B shows examples of XRD profiles of the starting Al₂O₃ and Nd-doped powders. For the 0.25 & 0.35 at. % case, there are peaks attributed to the Nd₂O₃ dopant as indicated by arrows FIG. 2C shows examples of XRD profiles of Al₂O₃ and Nd-doped ceramics. The un-optimized Nd doped sample show a clear secondary phase (indicated with an arrow). The optimized samples do not show signs of a secondary phase present. The inset on the right clearly shows peak shift relative to a α-Al₂O₃ standard (dashed line) for optimized Nd:Al₂O₃.

At processing temperatures of 1200° C. (undoped) and 1260° C. (Nd-doped) the samples may have fine AGS of ˜250 nm, near theoretical density, and are phase pure. As such, they possess long-range transparency (FIG. 2B) and when doped, emit light at the characteristic Nd³⁺ wavelength of 1064 nm when pumped with 806 nm which are prerequisites for gain. However, samples processed at 1300° C. may be diffuse and white, due to an increased AGS to ˜2.1 μm±0.25 μm for the un-doped α-Al₂O₃, and 1.9 μm±0.22 μm and 1.87 μm±0.23 μm, for the 0.25 at. % and 0.35 at. % Nd:Al₂O₃. At these larger grain sizes, the scattering efficiency is significantly higher (see FIG. 1A).

The CAPAD processing parameters were varied to optimize the microstructure and properties of various concentrations of Nd:Al₂O₃ (see methods below for details). FIG. 2A shows the effect of CAPAD temperature on the relative density of undoped samples and others doped with 0.25 and 0.35 at. % Nd. A sigmoidal temperature dependence is shown, where the density increases abruptly at a temperature referred to as the densification on-set temperature, T_{OD}. There is a clear influence of Nd dopant on T_{OD}. For the Nd doped Al₂O₃ samples, T_{OD} is ˜200° C. higher that the un-doped case (a shift from ˜900° C. to ˜1100° C.). There is also a small effect between the two different Nd concentrations on T_{OD}. The density of the 0.25 at. % Nd samples is slightly higher than the 0.35 at. % at most processing temperatures. Nd addition also affects the temperature to obtain full density; Relative densities >99% are achieved in the un-doped Al₂O₃ case at 1200° C. and ˜1260° C. for the Nd:Al₂O₃ samples.

Reduced densification kinetics may occur that is caused by RE addition in reaction/densification of ceramics. This may be due to the presence of the RE oxide dopant powder along the particle/grain boundaries when the two phases are still separate reactants. In our previous work on alumina with Tb as a dopant, the decrease in density was lower compared to the present case of Nd at similar global concentrations. The difference in behavior between the Nd and Tb dopants can be attributed to the larger ionic radius of Nd³⁺ (0.983 Å) compared to Tb³⁺ (0.923 Å). A similar shift in the T_{OD} with respect to RE ionic radius may occur for Nd³⁺, Eu³⁺, and Er³⁺ doped Al₂O₃ system (0.2 at. % RE:Al₂O₃ ratio, ˜0.04 at. % RE:Al) via free-sintering and hot-pressing.

FIG. 2B shows examples of XRD profiles of Al₂O₃ and Al₂O₃+Nd₂O₃ powders after Planetary Ball Milling (PBM) with varying Nd concentration. These XRD spectra examples show a peak at 2θ=30.72°, corresponding to the highest intensity peak for Nd₂O₃. Comparison of the XRD of the PBM starting powders to the α-Al₂O₃ reference does not show discernible peak shifts irrespective of Nd concentration, indicating that Nd³⁺ doping into the α-Al₂O₃ matrix did not occur through mechanical alloying during PBM.

FIG. 2C shows examples of XRD spectra of examples of fully dense polycrystals using optimized and non-optimized CAPAD conditions. The heating rate, processing temperature, and hold time of the optimized and non-optimized cases for these examples were similar (HR=300° C. min⁻¹, T=1260° C., HT=5 min); the largest difference in each case was the cooling rate, CR, which was significantly higher for the optimized case (optimized CR=300° C. min, non-optimized CR˜42° C. min). The XRD spectra of the non-optimized sample reveal an unwanted secondary phase, Nd₄Al₂O₉, (marked with an arrow). The highest intensity alumina peak is also at the same angle compared to the un-doped alumina ceramic, suggesting that Nd has not been adequately incorporated in the lattice.

By contrast, XRD of the ceramics processed using optimized CAPAD conditions reveal single phase α-Al₂O₃ with no signal from the starting Nd₂O₃ or from the ternary Nd₄Al₂O₉ and NdAlO₃ phases. This is in contrast to some previous reports that showed secondary phases in RE doped α-Al₂O₃ that have been produced at RE concentrations above the equilibrium solubility limit with other processing approaches. Moreover, the XRD spectra of the optimized Nd-doped samples reveal clear peak shifts to lower angles with increasing Nd concentration (Un-doped 2θ=35.18°, 2θ_{0.25 at. %}=34.09° and 2θ_{0.35 at. %}=34.98°). The dashed line in the inset on the right is the location of highest intensity peak from reference. This shift is evidence of stretching of the α-Al₂O₃ lattice from the doping of Nd-ions caused by CAPAD processing. The absence of the Nd₂O₃ reactant and ternary phases indicates a difference in the reaction kinetics associated with CAPAD processing in comparison to traditional processing approaches

Over-doping RE into Al₂O₃ to the high heating and cooling rates we employed in CAPAD processing that when optimized, produce a fine AGS and increase the RE-solubility may be due to increased reaction kinetics. The high heating rate ˜300° C. min⁻¹ allows reaching the desired temperature quickly, minimizing unwanted grain growth while achieving a near theoretical relative density, pre-requisites for high optical transparency in Al₂O₃. An increase in reaction kinetics associated with high heating rates may occur in the Ce:YAG system. A ˜20-fold increase in reaction coefficients may occur in comparison to reaction/densification in free-sintering using much slower heating rates. Since the largest difference between optimized and un-optimized samples was the CR, this parameter also plays a role in RE incorporation. The Nd solubility increases at higher temperatures so that the high CR has the effect of “freezing in” Nd, minimizing segregation. There is a synergistic effect between a fine AGS and RE incorporation during CAPAD.

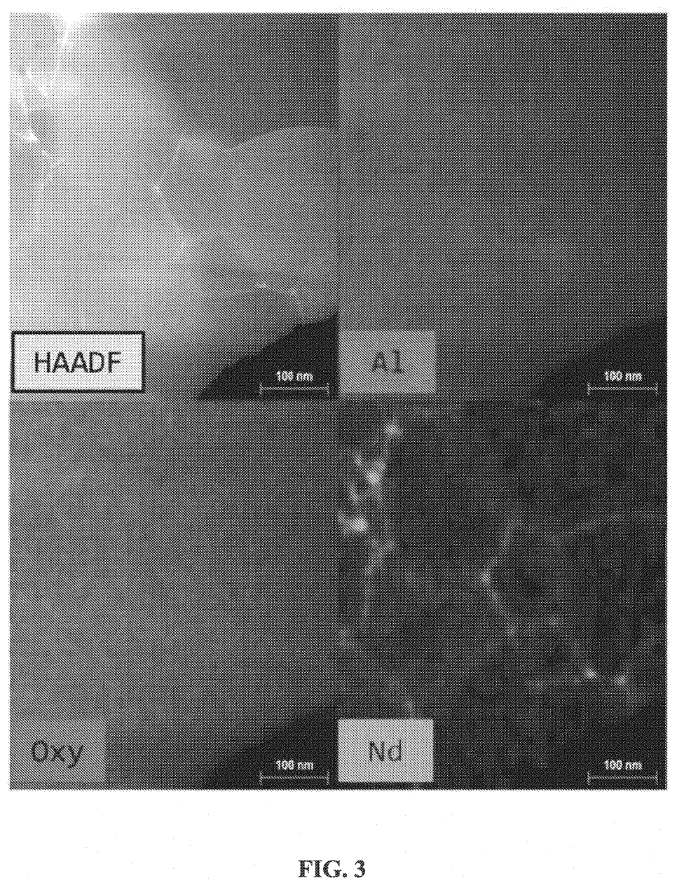

TEM may be used to further confirm incorporation of Nd into the alumina matrix. A high-angle annular dark-field (HAADF) TEM micrograph and corresponding energy-dispersive X-ray spectroscopy (EDS) distribution maps of a 0.35 at. % Nd:Al₂O₃ polycrystal (T=1260° C., HT=5 min, HR=300° C. min⁻¹, CR=300° C. min⁻¹) are shown in FIG. 3. The EDS maps reveal a portion of the Nd dopant is found within the matrix and along some grain boundaries and triple points. The minimal segregation corroborates the XRD spectra in FIG. 2C, that shows a shift of the XRD peaks to lower 26 angles and does not show the presence of unwanted secondary phases. This is in-line with observations by Rohrer and Harmer showing differences in the local grain boundary structure in RE doped α-Al₂O₃, and an increasing concentration gradient from the grain interior towards the grain boundary.

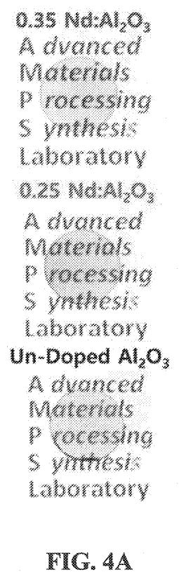

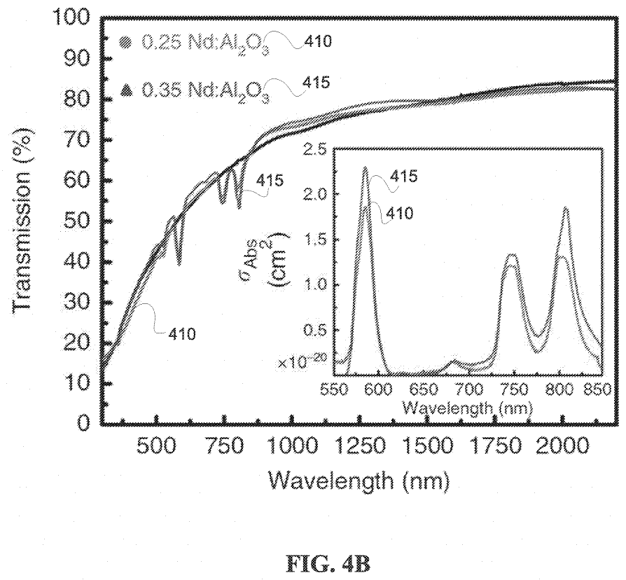

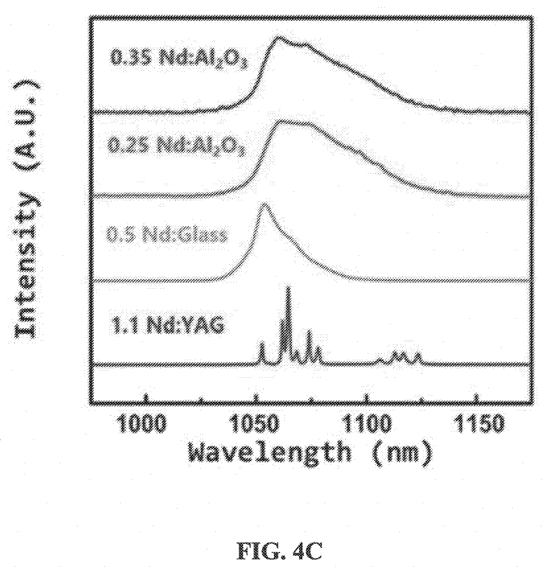

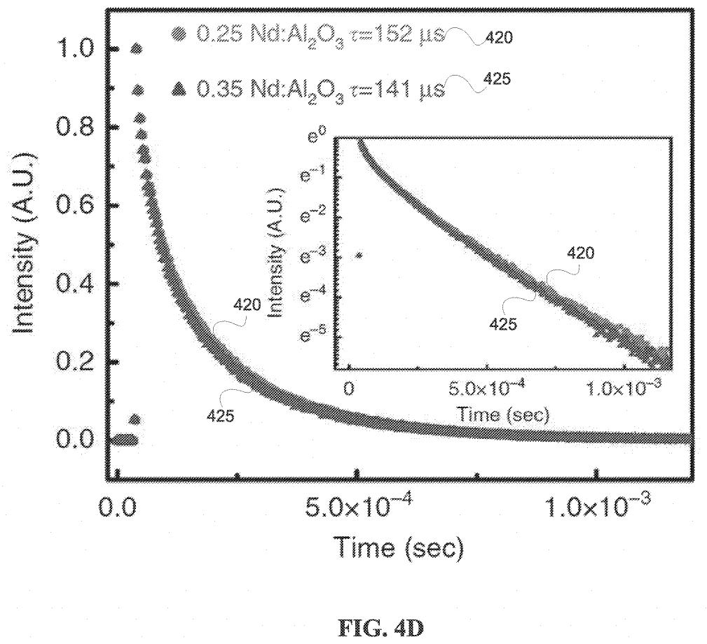

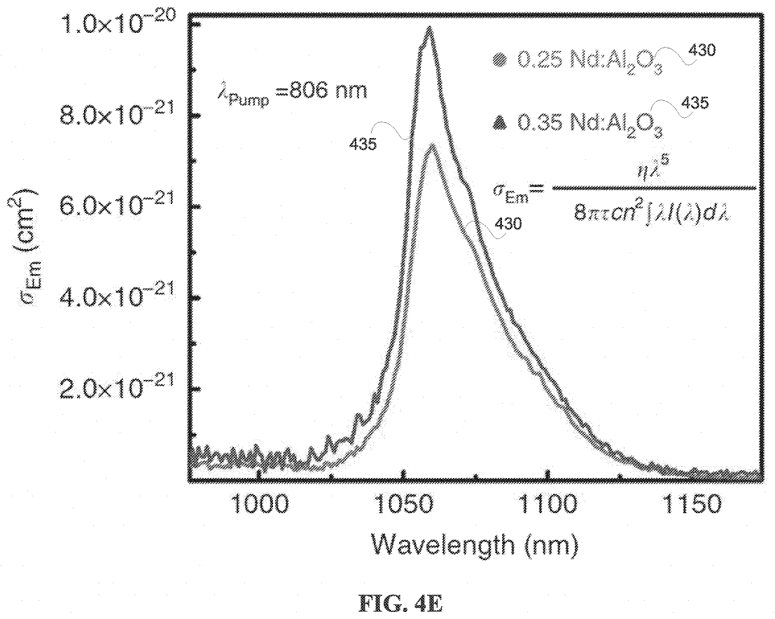

FIG. 4A-4E shows example optical properties of Nd:Al₂O₃. FIG. 4A shows pictures of Nd-doped and undoped ceramics. FIG. 4B shows transmission measurements of the Nd:Al₂O₃ and undoped Al₂O₃. All the ceramics show high transmission and importantly the Nd-doped samples have absorption bands characteristic of Nd³⁺ transmission. The corresponding absorption cross sections in the area of interest are shown in the inset. FIG. 4C shows examples of photoluminescence (PL) emission spectra for the 0.25 at. %, 0.35 at. % Nd³⁺:Al₂O₃ samples along with 0.5 at. % Nd³⁺:Glass, and 1.1 at. % Nd³⁺:YAG single crystal. Pump source is an 806 nm laser diode. The PL reveal broadened lines attributed to the ⁴F_{3/2}→⁴I_{11/2} electronic transitions. FIG. 4D shows the radiative lifetimes at 1064 nm for the Nd:Al₂O₃ ceramics produced under similar CAPAD processing conditions, log scale intensity is also shown. The lifetimes are 152 μs and 141 μs for the 0.25 and 0.35 at. % Nd:Al₂O₃, respectively (e) the resultant emission cross-sections, σ_{Em} using the Fuchbauer-Landendurg relationship (Eq. 3). The emission cross section peak is σ_{Em}=7.5×10⁻²¹ cm² for 0.25 at. % and 9.8×10⁻²¹ cm² for 0.35 at. % Nd:Al₂O₃ ceramics.

An example of optical transparency of consolidated bulk Nd:Al₂O₃ polycrystals is shown in FIG. 4A with the corresponding transmission spectra presented in FIG. 4B. The transmission values of the undoped alumina ceramics have similar transmissions to the Nd doped samples. In the area of interest for lasing of Nd³⁺ media at ˜1064 nm (⁴F_{3/2}→⁴I_{11/2} transition), the transmission is ˜75% for the Nd:Al₂O₃. The high transmission may be due to the high density (>99%), fine AGS (˜250 nm), low Nd segregation, and lack of secondary (undesired) phases in the Nd:Al₂O₃. Note that the transmission is not corrected for refection losses. Corrected for reflection losses, the transmission at 1064 nm is ˜90%, leading to a loss coefficient (absorption+scattering) of ˜1.317 cm⁻¹. For laser oscillation, a gain greater to this total loss is required for net positive gain. Our single-pass gain measurements below, show that the optical quality of our ceramics is indeed suitable for lasing.

A difference in the Nd:Al₂O₃ transmission spectra is the presence of the absorption bands centered at λ=583 nm (2.12 eV), 745 nm (1.85 eV), and 806 nm (1.54 eV), which correspond to the ⁴G_{5/2}, ⁴F_{7/2}, and ⁴F_{5/2} Stark transitions from the ⁴I_{9/2} manifold. The absorption bands associated with RE doping in Al₂O₃ and are strong evidence that the Nd³⁺ dopant is optically active within the ceramic matrix. The center of the Nd³⁺ absorption bands in Al₂O₃ are slightly blue shifted (˜2.5 nm), compared to Nd:YAG single crystals. The absorption bands are broadened in Nd:Al₂O₃ to AA-23 nm (FWHM) from ˜AA-˜2 nm compared to Nd:YAG, which is consistent with the Nd³⁺ being found on multiple doping sites within the alumina matrix. Moreover, the depth of the absorption bands increases with the dopant concentration, indicating more optical activity from the Nd³⁺ ions within the 0.35 at. % Nd:Al₂O₃ sample.

The absorption cross-sections, σ_{abs} for the region of interest are shown in the inset in FIG. 4B. These σ_{abs} were calculated from the measured transmission corrected for reflection and scattering losses. In dense polycrystalline ceramics with anisotropic crystal structure (uniaxial in this case) one should also correct for scattering losses caused by the birefringence to not overestimate σ_{abs}. Scattering losses may be corrected using the Rayleigh-Gans-Debye (RGD) approach where the scattering has a 1/λ² dependence as discussed previously for transition metal-doped alumina. Agreement between the calculated and measured transmission spectra (not shown here) for the un-doped Al₂O₃ ceramics confirm that the uniaxial crystal structure is the main source of scattering as opposed to porosity and validates the use of RGD method.

For the ⁴F_{5/2} transition, which is of interest for diode pumped lasers, the peak σ_{abs} are 1.36×10⁻²⁰ cm² and 1.69×10⁻²⁰ cm² for the 0.25 at. % and 0.35 at. % Nd:Al₂O₃. These cross-sections compare well with single-crystal 1.1 at. % Nd:YAG, (σ_{abs}˜7.7×10⁻²⁰ cm²). The slightly lower σ_{abs} in Nd:Al₂O₃ may indicate the presence of Nd sites that are not optically active, or by the absorption band broadening, which also occurs in Nd:Glass and in Nd:YVO₄.

FIG. 4C depicts an example of PL emission spectra for the 0.25 at. %, 0.35 at. % Nd³⁺:Al₂O₃ ceramics, 0.5 at. % Nd³⁺:Glass (Schott), and 1.1 at. % Nd³⁺:YAG (single crystal, Litton Technologies, Inc.), resulting from pumping at λ=806 nm. The media show emission at similar wavelengths but different line shapes and bandwidths for the ⁴F_{3/2}→⁴I_{11/2} transition. The single crystal profile shows narrow well-defined peaks typical of single site doping. By contrast emission peaks in Nd³⁺:Al₂O₃ appear inhomogeneously-broadened similar to Nd³⁺ glass although the overall PL bandwidth is wider than the laser glass. Inhomogeneous broadening of the Nd³⁺:Al₂O₃ emission lines is not surprising given that Nd ions are found on multiple sites including grain interiors, grain boundaries and triple points (FIG. 3). This broadening contrasts with PL behavior in 2 at. % Nd:Al₂O₃ on thin films produced with pulsed laser deposition (PLD). Lasing in epitaxial films that showed narrow emission lines for the ⁴F_{3/2}→⁴I_{11/2} transition producing PL at 1097 nm. The shifted emission peak and single crystal Nd:YAG may be because epitaxial thin films often display shifts compared to bulk materials. This may be due to the sharp emission peaks to single site doping, particularly, the substitution of Nd³⁺ onto the Al³⁺ lattice. Despite the sharp PL peaks, significant absorption cross-section may not be observed due to the possibility of dead Nd-sites which do not contribute to absorption or PL.

The gain bandwidth (G_{bw}) can be approximated by measuring the full-width at half-maximum (FWHM) of the PL emission peaks. In some example embodiments, G_{bw}=0.6 nm (0.16 THz) for Nd³⁺:YAG and G_{bw}=20 nm (5.4 THz), for Nd³⁺:Glass which agree well with previous measurements. The G_{bw}˜49 nm (13 THz) of our Nd³⁺:Al₂O₃ may be the highest bandwidths measured for Nd³⁺ in any media. For bandwidth-limited pulses, the achievable pulse duration of a gain medium is determined by G_{bw}. The broader the emission spectra, the shorter the pulse and the pulse width can be estimated using, Δ_{τP}=1/G_{bw}. Using G_{bw} measurements, we find Δ_{τP}˜7.7 fs. The large bandwidth of Nd³⁺:Al₂O₃ may cause generation of high peak-power lasers by generation of ultra-short time pulses. These bandwidth-limited pulse widths represent a 2.5 fold increase in the single-shot peak power over Nd³⁺ glass and >80 fold increase over Nd³⁺:YAG (Δ_{τP}=6.3 μs for Nd³⁺:YAG, Δ_{τP}=18.5 fs for Nd³⁺:Glass), through pulse width compression. These estimated improvements are conservative since thermal shock resistance for Nd:Al₂O₃ (Rs˜19,500 Wm⁻¹) is superior to Nd:YAG (Rₛ˜800 Wm⁻¹) and Nd:Glass (Rₛ˜1 Wm⁻¹), indicating the possibility to scale peak power extraction accordingly.

Given the absorption and PL characteristics, the radiative lifetimes were measured, τ, at 1064 nm for the Nd:Al₂O₃ ceramics for example optimized samples. The lifetimes are 152 μs and 141 μs for the 0.25 and 0.35 at. % Nd:Al₂O₃, respectively (FIG. 4D). These lifetimes compare well with other proven gain media; they are longer than those observed by others in 2 at. % Nd:Sapphire, but are shorter than those of Nd:YAG (230 μs) and Nd:Glass (330 μs). The small decrease in τ as the Nd concentration increases, for the 0.25 to the 0.35 at. % samples may indicate the onset of concentration quenching. By contrast, the un-optimized 0.35 at. % Nd:Al₂O₃ sample (significantly reduced CR˜42° C. min⁻¹) results in a significant decrease in τ˜50 μs. This is consistent with the observation of clear secondary phases in the XRD analysis. Further spectroscopic and processing studies are required to fully understand concentration quenching in Nd:Al₂O₃. FIG. 4E depicts an example of emissions spectra for doped Al₂O₃, in accordance with some example embodiments.

From the PL emission spectra, the emission cross-sections, σ_{Em} using the Fuchbauer-Landendurg relationship may be expressed as,

$${σ}_{E m} = \frac{n {λ}^{5}}{8 π τ c {n}^{2} \int λ I ( λ ) d λ} \qquad Equation ( 2 )$$

The σ_{Em} are large and adequate for lasing across the PL bandwidth; the peak σ_{Em}=7.5×10⁻²¹ cm² for 0.25 at % and 9.8×10⁻²¹ cm² for 0.35 at. % ceramics processed at CR=300° C. min⁻¹. These σ_{Em} are consistent with σ_{Abs} derived from the measured transmission spectra. By contrast the σ_{Em} is 3.1×10⁻²² cm² for the un-optimized sample. The substantially lower σ_{Em} proves that the presence of second phases deteriorates the optical activity for the Nd-dopant.

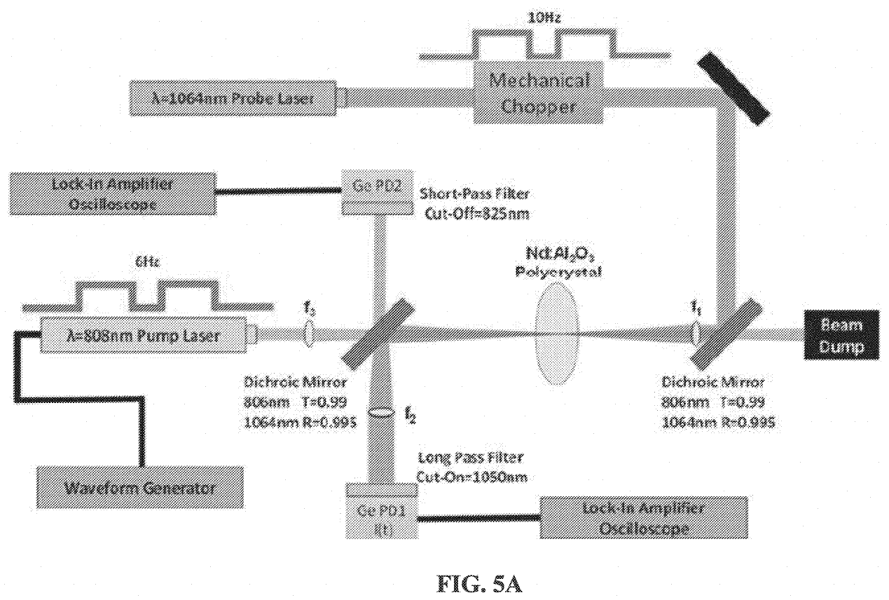

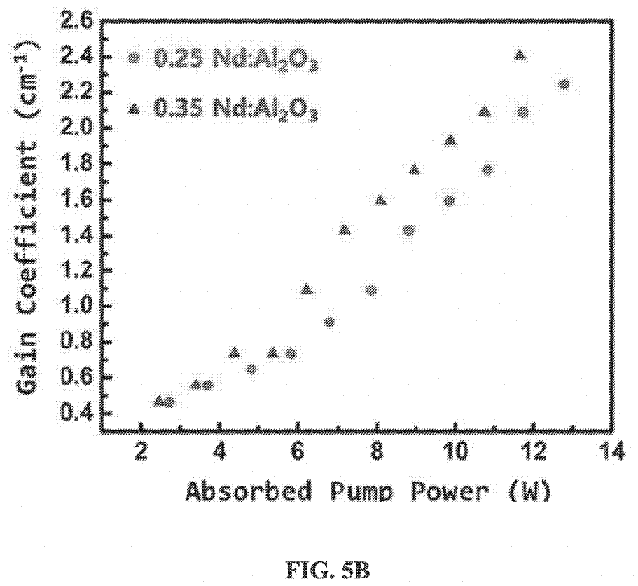

To ascertain the viability for lasing in Nd³⁺:Al₂O₃ their small signal gain coefficients may be measured using a single pass arrangement. The schematic for the optical arrangement is shown in FIG. 5A. A 1064 nm probe beam was passed through a specimen at a constant incident power. An 806 nm pump laser was introduced onto the same spatial location on the test specimens using a dichroic optic with high-transmission (99% at 806 nm) and high-reflection (99.5% at 1064 nm). The increase/decrease in the probe beam intensity as a function of absorbed pump power was monitored by the same photodiode. A modified version of the Beer-Lambert law for homogenous/Doppler broadened gain media may be used to measure gain coefficients:

I_{F}=(z)=Iₒ(z)e^{[g}^{ₒ}^{]·z} Equation (3)

where Iₒ(z) and I_{F}(z) are the intensities of the probe laser after having passed through the test specimen of thickness z, prior to and with pumping, respectively, and g₀ is the small-signal gain coefficient, obtained here in a single-pass arrangement.

FIG. 5B plots the gain coefficients for the 0.25 at. % and 0.35 at. % Nd³⁺:Al₂O₃ ceramics as a function of absorbed pump power. The inset schematically shows the relationship between the pump, probe and gain signals and Eq. 4. A gain in the transmitted probe-laser at absorbed pump powers >2.25 W was observed for both materials. The magnitude of g₀ increases approximately linearly as a function of the absorbed pump power and in this power range, we do not observe gain saturation. The gain values are as high as 2.27 cm⁻¹ and 2.42 cm⁻¹ for the 0.25 at. % and 0.35 at. % Nd³⁺ concentrations, respectively. Other gain values including higher gain values may be achieved using the disclosed techniques. These small-signal gain coefficients compare well to values for Nd:YAG (2 cm⁻¹), Nd:Glass (5 cm⁻¹), Ti:Sapphire (1 cm⁻¹) and Cr:Sapphire (1 cm⁻¹). As discussed above, the disclosed materials have scattering and absorption loss that are ˜1.317 cm⁻¹ after having corrected reflection loss. It is worth noting that reflection loss can be mitigated using anti-reflection coatings on the ceramic. These single-pass gain measurements reveal a net positive gain at absorbed pump powers of >8 W and 7.2 W, for the 0.25 at. % and 0.35 at. % Nd:Al₂O₃, where g₀ surpasses the absorption and scattering loss. These measurements, indicate that the optical quality (transparency, τ, σ_{Abs}, and σ_{Em}) of Nd³⁺:Al₂O₃ bulk ceramics is suitable for amplification and oscillation should optical feedback be introduced, i.e. within a laser cavity employing AR-coatings on the gain medium.

The demonstration of gain may be related to the nanostructure of the ceramics. The fine AGS results in an Al₂O₃ with a large grain boundary volume, which facilitates the accommodation of the RE without significant concentration quenching. In addition to microstructural control, high heating and cooling rates during CAPAD processing also affect the incorporation of Nd³⁺ into the grain and grain boundary regions without the formation of unwanted secondary phases that lead to poor optical activity.

In summary, a powder processing route in conjunction with single-step CAPAD reaction/densification is disclosed to produce transparent bulk polycrystalline Nd³⁺:Al₂O₃ with over-equilibrium Nd-doped (0.25 at. % and 0.35 at. %) concentrations. The ceramics have a high transmission at 1064 nm and display absorption bands at λ=585 nm, 748 nm, and 806 nm, corresponding to transitions from the ⁴I_{9/2} manifold of optically active Nd³⁺, resulting in high peak absorption cross-sections. The PL bandwidth of ˜13 THz centered at 1064 nm represents a new record for Nd³⁺ media, permitting the generation of ultrashort pulses. The radiative lifetimes are long and give a large emission cross-section, which result in optical gain that is suitable for amplification and lasing. Moreover, the significantly higher Rₛ˜19,500 W/m of Nd³⁺:Al₂O₃ promise a significantly higher duty-cycle and/or peak-power, making Nd³⁺:Al₂O₃, a potentially revolutionary gain material. Finally, the nano/microstructural strategies demonstrated here may be applicable to many other oxide and nitride gain systems that were not previously believed to be laser ceramics and thus represents a fundamentally new approach to producing gain media.

### Materials and Methods

Relations Between Interionic Distance, Grain Size and Effective Length

A factor for gain is the average distance between dopant ions, \tilde{l}. Dopant concentrations, c are usually reported in [at. %] relative to cations. Interionic distances may be understood using volumetric concentration, cᵥₒₗ [ions/cm³] because \tilde{l} scales with total number of ions in a volume, V such that \tilde{l} ∝∛\sqrt{1/cᵥₒₗV}. While calculations or measurements of \tilde{l} can be complicated, it is easy to obtain a good estimate of \tilde{l} using a regular pattern of dopants such as a simple cubic cell with RE on each corner with I as a cell length. In this case \tilde{l}˜I=∛\sqrt{1/cᵥₒₗV}. Laser quality Nd:YAG used as an example, where the typical dopant concentration is 1-2 at. %. In the c=0.25 at. % case, cᵥₒₗ=7.53×10²⁰ ions/cm³ so that \tilde{l}˜1.09 nm.

Alternate dopant distributions may be considered. Consider one crystallite of gain media approximated as a cube with global volumetric dopant concentration, cᵥₒₗ [ions/cm³]. The total number of ions, N in the volume of that cube is equal to cᵥₒₗd 3 where d is the cube edge length. If all the dopant ions in that cube are placed on the surface (i.e. grain boundary) rather than in the grain volume, one can calculate the effective length (edge length), d_{eff} necessary to accommodate all the dopants for a given arrangement on the surface of the cube. For simplicity, the random arrangement of ions can be approximated as a regular square unit cell with cell parameter 2r+I, where r is ionic radius and I is the distance between dopant ions. Since there are 6 sides to a cube, d_{eff} as a function of grain size (edge length), d is:

$${d}_{e f f} = \sqrt{\frac{{d}^{3} {{c}_{v o l} ( 2 r + l )}^{2}}{6}} \qquad Equation ( 4 )$$

A value of r=1.15 Å for Nd ions and I=1 nm was used for calculations, since 1 nm is a good approximation of \tilde{l} as shown above.

Powder Preparation

α-Al₂O₃ (e.g., 99.99% purity) may be processed as received (un-doped) and doped with Nd₂O₃ (e.g., 99.99% purity). The powders may be mixed to achieve a doping level (Nd³⁺:Al³⁺) of 0.25 and 0.35 at. %. The powders may be mixed dry in an alumina mortar by hand for 20 min, followed by low-energy ball milling for 12 hrs with Ultra-High Purity (UHP, 99.99% purity) water as a dispersant. The slurries may be sieved and centrifuged for 15 min at 3400 RPM. The powders may be dried in a vacuum oven at 70° C. under a vacuum of 30 mm Hg for 12 hrs. Dried powders were subsequently planetary ball milled with UHP water at 150 RPM for 6 hrs. Finally, the powders may be sieved and dried in air at 120° C. for 12 hrs and kept dry until consolidation.

CAPAD Processing

The powders may be densified by CAPAD using a graphite die (19 mm outer and 10 mm inner diameter). This die and plunger set may be secured between two 19 mm punches and placed within a larger graphite die with a 19 mm inner diameter. The die and powder set may be placed into the CAPAD and a vacuum of 10⁻³ Torr established. The powders may be pre-pressed at 106 MPa for 20 minutes after which the load may be released. An ultimate pressure of 106 MPa with a pressure ramp of 35.33 MPa min⁻¹ may be applied and held constant. In parallel with pressure application, the samples may be subjected to a heating rate of ˜300° C. min⁻¹ and a maximum temperature ranging between 700-1300° C. with a hold time of 5 min. The temperature may be monitored with a dual wavelength optical pyrometer focused at the die midpoint.

Microstructural Characterization

Powders and densified ceramics may be characterized using X-Ray diffraction (XRD) using Cu Kα₁ (λ=1.54058 Å) radiation using, for example, a PANalytical Empyrean Diffractometer (PANalytical, Almelo, The Netherlands) using a step size of 26=0.0050. Published standards may be used for comparison: Nd₂O₃ (ICSD #26867), and α-Al₂O₃(ICSD #:63647).

The average grain size (AGS) of the densified ceramics may be obtained from fracture surfaces by measuring >300 grains in multiple micrographs at random locations. The fractured surface may be sputter coated with a thin film of Pt/Pd before examination with a Phillips XL30 Field Emission Scanning Electron Microscope (FE-SEM). EDS mapping was performed using a Titan Themis 399 Scanning-TEM (STEM). The TEM specimen may be prepared using a gallium Focused Ion Beam (FIB) and attached to a copper TEM grid using a Pt FIB.

Transmission and Photoluminescence (PL) Measurements

The samples may be polished with diamond suspensions to 0.5 μm. The final specimen thickness was 0.8 mm±0.05 mm. Transmission spectra may be taken on, for example, a Varian Cary 500 UV-VIS-IR spectrometer from 300 nm to 2200 nm at normal incidence, in single-beam mode with a rectangular spot size of 2 mm by 9 mm, using a scan rate of 0.2 nms⁻¹.

PL may be measured on, for example, a Horiba Spex Fluorolog 3 Spectrophotometer using an 806 nm laser diode as the excitation source with a 100 mW incident power and a spot size of 2 mm. Measurements may be taken in front face mode at 45° angle of incidence (AOI) on polished samples. Emission scans may be taken between λ=1000 nm and λ=1100 nm with an integration time of 1 snm⁻¹.

Photoluminescence Lifetime Measurements

PL lifetimes (pump=806 nm) may be obtained using a pulsed tunable laser (Continuum Surelite with Optical Parametric Oscillator (OPO). For example, the pulse width was 6 ns, the spot size was 6 mm, and the incident energy was 3 mJ per pulse. The ceramics may be mounted within, for example, a Horiba Spex Fluorolog 3 Spectrophotometer, which may be coupled to a germanium photodiode and synchronized to a Tektronix TPS2024B oscilloscope. The monochromators may be adjusted to observe 1064 nm, with a spectral bandwidth of 1 nm. An optical notch filter centered at 1064 nm with 8 nm FWHM transmission band may be used to further isolate the pump source. Measurements may be taken in front face mode at 45° AOI. A double-exponential may be used to fit data and extract the lifetimes, where t, is defined as the time required for the intensity to decrease by 1/e.

Single-Pass Optical Gain

Optical gain may be measured using a single-pass arrangement shown schematically in FIG. 5B. The samples may be held within an aluminum mount atop a 6-axis kinematic mount that may be modified for water cooling, allowing a constant sample temperature of 15° C. throughout measurements.

A continuous wave Nd:YAG laser, operating at the fundamental wavelength (λ=1064 nm) may be used as the probe laser. The collimated probe beam (˜1 mm diameter) may be focused onto the sample with a 100 mm focal length lens, resulting in a FWHM spot size of ˜220 μm. A fiber coupled Coherent FAP 35 W laser diode (λ=806 nm) and collimator may be the pumping source. The pump laser may be focused onto the sample collinear to, but counter-propagating with respect to the probe using a 35 mm focal length lens resulting in a spot size of ˜400 μm. The spot sizes may be determined by fitting a gaussian profile to the probe laser and a top-hat profile to the pump laser from CCD images of the focused beams. The pump beam waist was injected into the arrangement via a dichroic mirror (Thorlabs DMSP1000) with a reflective cut-on wavelength of 1000 nm at 45° AOI. In addition to the factory dielectric coatings, an additional anti-reflective coating for 806 nm was deposited onto the dichroic optics, which maximized the deliverable pump power onto the test specimens, while minimizing stray Fresnel reflections for the pump laser.

The focusing optics for the probe and pump beams may be mounted on 6-axis kinematic fixtures, allowing precise spatial alignment of the beams within a single sample interaction volume. The pump and probe beam power may be monitored with germanium photodetectors (for example, a Thorlabs PDA50B), PD1 and PD2, respectively, which may be optically isolated to the desired wavelengths with low and high-pass filters. The pump and probe lasers may be operated in quasi-continuous mode using an 8 Hz and 10 Hz boxcar waveform, respectively. The fluctuations in the pump and probe laser intensities may be recorded using a lock-in amplifier in parallel with an oscilloscope at their respective operating frequencies. This ensures that fluctuations in PD signals are isolated. The photodetectors may be calibrated against an optical power meter (for example, a Ophir Nova 2).

The disclosed technology can be embodied in the form of a laser apparatus that includes a polycrystalline material. The polycrystalline material may include a ceramic material and a rare earth dopant. The ceramic material may have a grain size and the rare earth dopant may have a predetermined concentration, which result in the polycrystalline material exhibiting an optical gain (e.g., greater than unity amplification) at a laser wavelength. The polycrystalline material may be positioned to receive pumping light at a pumping wavelength and produce the optical gain for laser oscillation at the laser wavelength that is different from the pumping wavelength.

The disclosed technology may be embodied in the form of a polycrystalline material that includes a ceramic material with a predetermined grain size and a rare earth dopant with a predetermined concentration, wherein the predetermined grain size and the predetermined concentration cause the polycrystalline material to exhibit an optical gain at a predefined wavelength.

In some implementations, wherein the predetermined grain size is less than the pump wavelength. In some implementations, a distribution of the rare earth dopant has a minimal segregation at grain boundaries. In some implementations the pump wavelength of the pumping light is 806 nanometers (nm) or within plus-minus one percent of this wavelength. In some implementations, the laser wavelength is 1064 nanometers (or within 1 percent of this value). In some implementations, the laser wavelength is between 1000 nm and 2000 nm. In some implementations, the ceramic material is alumina (Al₂O₃). In some implementations, the rare earth dopant is neodymium (Nd). In some implementations, the rare earth dopant is one or more of neodymium (Nd), erbium (Er), thulium (Tm), holmium (Ho) or ytterbium (Yb), providing a wider selection of laser wavelengths at the output.

In some example embodiments, a method of manufacturing a laser apparatus includes manufacturing a polycrystalline material configured to receive pumping light at a pump wavelength and to produce an optical gain for laser oscillation at a laser wavelength different from the pump wavelength. The polycrystalline material includes a ceramic material with a predetermined grain size, and a rare earth dopant with a predetermined concentration, wherein the predetermined grain size and the predetermined concentration cause the polycrystalline material to exhibit the optical gain at the laser wavelength. For example, as described in the present document, a particular grain size and/or concentration may be used to achieve a particular desired optical gain, or amplification, at the laser wavelength.

In some example embodiments, a method of manufacturing a polycrystalline material includes selecting a ceramic material with a predetermined grain size, and a rare earth dopant with a predetermined concentration, wherein the predetermined grain size and the predetermined concentration cause the polycrystalline material to exhibit the optical gain at the laser wavelength. For example, as described in the present document, to achieve a specific optical gain at a laser wavelength, a specific grain size and/or a specific concentration can be selected for the ceramic material and the rare earth dopant.

Although a few variations have been described in detail above, other modifications or additions are possible. In particular, further features and/or variations may be provided in addition to those set forth herein. Moreover, the example embodiments described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

Similarly, while operations are depicted in the drawings in a particular order, this should not be understood as requiring that such operations be performed in the particular order shown or in sequential order, or that all illustrated operations be performed, to achieve desirable results. Moreover, the separation of various elements in the embodiments described in this patent document should not be understood as requiring such separation in all embodiments.

Only a few implementations and examples are described and other implementations, enhancements and variations can be made based on what is described and illustrated in this patent document.

1. A laser apparatus, comprising:
a polycrystalline material configured to receive pumping light at a pump wavelength and to produce an optical gain for laser oscillation at a laser wavelength different from the pump wavelength, the polycrystalline material comprising:
a ceramic material with a predetermined grain size; and
a rare earth dopant with a predetermined concentration, wherein the predetermined grain size and the predetermined concentration cause the polycrystalline material to exhibit the optical gain at the laser wavelength.

2. The laser apparatus of claim 1, wherein the predetermined grain size is less than the pump wavelength.

3. The laser apparatus of any of claim 2, wherein a distribution of the rare earth dopant has a minimal segregation at grain boundaries.

4. The laser apparatus of any of claim 3, wherein the pump wavelength of the pumping light is 806 nanometers (nm).

5. The laser apparatus of any of claim 4, wherein the laser wavelength is 1064 nanometers.

6. The laser apparatus of any of claim 4, wherein the laser wavelength is between 1000 nm and 2000 nm.

7. The laser apparatus of any of claim 6, wherein the ceramic material is alumina (Al₂O₃).

8. The laser apparatus of any of claim 7, wherein the rare earth dopant is neodymium (Nd).

9. The laser apparatus of any of claim 7, wherein the rare earth dopant is one or more of neodymium (Nd), erbium (Er), thulium (Tm), holmium (Ho) or ytterbium (Yb).

10. A polycrystalline material, comprising:
a ceramic material with a predetermined grain size; and
a rare earth dopant with a predetermined concentration, wherein the predetermined grain size and the predetermined concentration cause the polycrystalline material to exhibit an optical gain at a predefined wavelength.

11. The polycrystalline material of claim 10, wherein the predetermined grain size is less than a wavelength of a pumping light.

12. The polycrystalline material of any of claim 11, wherein the polycrystalline material is pumped at a pumping wavelength of 806 nm.

13. The polycrystalline material of any of claim 12, wherein a distribution of the rare earth dopant has a minimal segregation at grain boundaries.

14. The polycrystalline material of any of claim 13, wherein the predefined wavelength is 1064 nm.

15. The polycrystalline material of any of claim 13, wherein the predefined wavelength lies between 1000 nm and 2000 nm.

16. The polycrystalline material of any of claim 15, wherein the ceramic material is alumina (Al₂O₃).

17. The polycrystalline material of any of claim 16, wherein the rare earth dopant is neodymium (Nd).

18. The polycrystalline material of any of claim 16, wherein the rare earth dopant is one or more of neodymium (Nd), erbium (Er), thulium (Tm), holmium (Ho) or ytterbium (Yb).
